(19) United States
(12) Patent Application Publication
(10) Pub. No.: US 2019/0263166 A1
(43) Pub. Date: Aug. 29, 2019

(54) SUBLIMATION THERMAL TRANSFER SHEET, AND COMBINATION OF SUBLIMATION THERMAL TRANSFER SHEET AND TRANSFER RECEIVING ARTICLE

(71) Applicant: Dai Nippon Printing Co., Ltd., Tokyo (JP)

(72) Inventors: Emi MATSUBA, Tokyo (JP); Shinya YODA, Tokyo (JP); Junpei OOMURA, Tokyo (JP)

(73) Assignee: Dai Nippon Printing Co., Ltd., Tokyo (JP)

(21) Appl. No.: 16/089,089

(22) PCT Filed: Mar. 31, 2017
(86) PCT No.: PCT/JP2017/013621

§ 371 Date: Sep. 27, 2018

(30) Foreign Application Priority Data
Mar. 31, 2016 (JP) 2016-071743

(51) Int. Cl. B41M 5/39; B41M 5/44

(52) U.S. Cl. CPC B41M 5/39; B41M 2205/38; B41M 2205/02; B41M 5/44

(57) ABSTRACT

The present invention provides a Sublimation thermal transfer sheet capable of coping with high-speed printers, securing desired densities, and further excellent in the lightfastness and the durability of the print, and a combination of the Sublimation thermal transfer sheet and a transfer receiving article. In the Sublimation thermal transfer sheet provided with at least a yellow colorant layer, a magenta colorant layer, and a cyan colorant layer provided in this order on a substrate, as being frame sequentially, predetermined colorants are contained in predetermined contents in the yellow colorant layer and the magenta colorant layer.

### TECHNICAL FIELD

The present invention relates to a Sublimation thermal transfer sheet, and a combination of a Sublimation thermal transfer sheet and a transfer receiving article.

### BACKGROUND ART

As a method of forming an image using thermal transfer, there has been known a sublimable type thermal transfer method in which a so-called Sublimation thermal transfer sheet prepared by carrying colorants on a substrate such as a plastic film, and a thermal transfer image-receiving sheet prepared by providing a colorant-receiving layer on another substrate such as a sheet of paper or a plastic film are superposed on each other to form a full-color image. This method uses so-called sublimable colorants, hence is excellent in the reproducibility of neutral tints and gradation, and is capable of clearly representing a full-color image faithful to the original image on a thermal transfer image-receiving sheet, and has consequently been used in the color image formation in digital cameras, videos, computers and the like. The images concerned are of high quality comparable to the quality of silver-salt photographs.

Such a Sublimation thermal transfer sheet is disclosed, for example, in Patent Document 1.

### PRIOR ART LITERATURE

### Patent Literature

Patent Document 1: JP 2005-88515 A

### SUMMARY OF THE INVENTION

### Problems to be Solved by the Invention

Recently, the achievement of high speed in printers adopting the sublimable type thermal transfer method is remarkable, and the development of a Sublimation thermal transfer sheet adaptable to this high speed has been demanded. Specifically, when a printer achieves a high speed, a Sublimation thermal transfer sheet undergoes an application of an energy more than hitherto, and hence it has been demanded a development of a Sublimation thermal transfer sheet capable of withstanding high energy, securing desired densities, and also excellent in the lightfastness and the durability of the print.

The present invention has been made in view of the above-mentioned circumstances, and the present invention aims principally to provide a Sublimation thermal transfer sheet capable of coping with high-speed printers, securing desired densities, and further excellent in the lightfastness and the durability of the print, and a combination of the Sublimation thermal transfer sheet and a transfer receiving article.

### Means for Solving the Problems

The present invention to solve the above-mentioned problems is a sublimation thermal transfer sheet that comprises a substrate, and at least yellow, magenta, and cyan colorant layers provided on the substrate, as being frame sequentially, wherein the yellow colorant layer contains at least the colorant represented by the following general formula (Y-I), and the content of the colorant represented by the following general formula (Y-I) on the basis of the total mass of the whole of the colorants contained in the yellow colorant layer is 60% by mass or more; the magenta colorant layer contains at least the colorant represented by the following general formula (M-I), and either one or both of the colorant represented by the following general formula (M-II) and the colorant represented by the general formula (M-III); and the content of the colorant represented by the following general formula (M-I) on the basis of the total mass of the whole of the colorants contained in the magenta colorant layer is 10% by mass or more and 50% by mass or less.

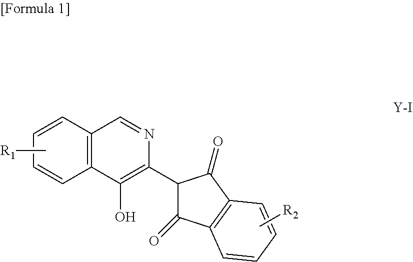

(In the general formula (Y-I), R₁ represents a linear or branched alkyl group having 8 or less carbon atoms, a substituted or unsubstituted aryl group, a hydrogen atom, or a halogen atom; and R₂ represents a substituted or unsubstituted carbonylamino group or a substituted or unsubstituted carbonylalkoxy group.)

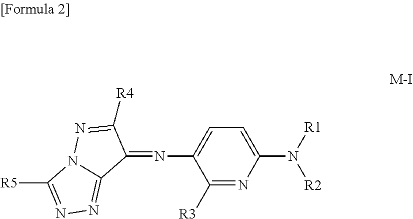

(In the general formula (M-I), R1 and R2 each represent a hydrogen atom, a linear or branched alkyl group, a substituted or unsubstituted cycloalkyl group or a substituted or unsubstituted aralkyl group; R3 represents a linear or branched alkyl group, a substituted or unsubstituted alkoxy group, a substituted or unsubstituted alkylcarbonylamino group, a substituted or unsubstituted alkylsulfonylamino group, a substituted or unsubstituted alkylaminocarbonyl group, a substituted or unsubstituted alkylaminosulfonyl group, a hydrogen atom, or a halogen atom; and R4 and R5 each represent a linear or branched alkyl group, a substituted or unsubstituted aryl group, a substituted or unsubstituted amino group, a substituted or unsubstituted cycloalkyl group, a cyano group, a nitro group, or a halogen atom.)

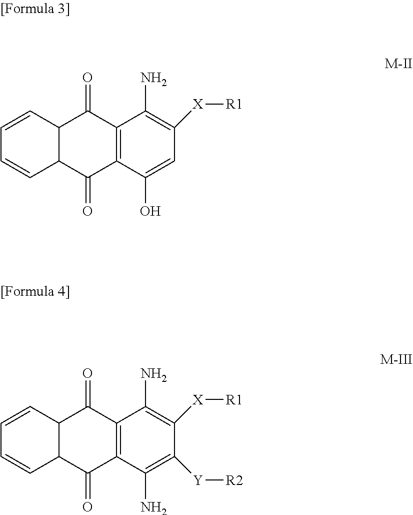

(In the general formulas (M-II) and (M-III), X and Y each represent S, O or SO₂; and R1 and R2 each represent a linear or branched alkyl group, a substituted or unsubstituted cycloalkyl group, a substituted or unsubstituted aryl group, or a substituted or unsubstituted allyl group.)

Another present invention to solve the above-mentioned problem is a combination of a Sublimation thermal transfer sheet and a transfer receiving article, wherein the Sublimation thermal transfer sheet is a Sublimation thermal transfer sheet according to claim 1, and the transfer receiving article is a card material wherein the magnitude of deflection in the flexural strength test specified in JIS X 6305-1 is 35 mm or less.

### Effect of the Invention

According to the Sublimation thermal transfer sheet, and the combination of the Sublimation thermal transfer sheet and the transfer receiving article, of the present invention, it is possible to cope with a high speed printer and it is possible to securer a desired density. In addition, a print formed by using the Sublimation thermal transfer sheet of the present invention is also excellent in lightfastness and durability.

### BRIEF DESCRIPTION OF THE DRAWINGS

FIG. 1 is a schematic cross-sectional view illustrating an example of the Sublimation thermal transfer sheet of the present invention.

### EMBODIMENTS OF THE INVENTION

Hereinafter, the Sublimation thermal transfer sheet of the present invention is described in detail.

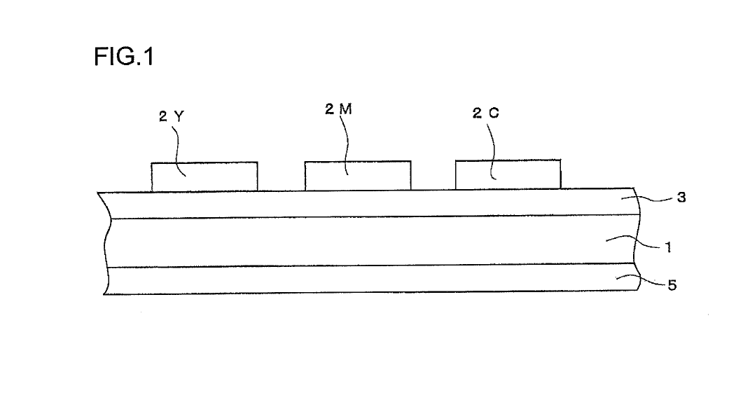

FIG. 1 is a schematic cross-sectional view showing an example of the Sublimation thermal transfer sheet of the present invention.

As shown in FIG. 1, the Sublimation thermal transfer sheet 10 according to an embodiment of the present invention is provided on a substrate 1 with a yellow colorant layer 2Y, a magenta colorant layer 2M, and a cyan colorant layer 2C, in this order as being frame sequentially, wherein in the yellow colorant layer 2Y and in the magenta colorant layer 2M, predetermined colorants are contained in predetermined amounts. It is to be noted that in the Sublimation thermal transfer sheet 10 according to the present embodiment shown in FIG. 1, a primer layer 3 is provided between the substrate 1 and each of the colorant layers 2Y, 2M, and 2C, and a back face layer is provided on the face opposite to the face of the substrate 1, provided with the respective colorant layers 2Y, 2M, and 2C; these layers are optional layers. Hereinafter, the respective constitutions of the Sublimation thermal transfer sheet 10 according to the present embodiment are described specifically.

### (Substrate)

As the substrate 1, any conventional material having a certain heat resistance and a certain strength can be appropriately used without being particularly limited. Examples of such a substrate 1 include films having a thickness of 0.5 μm or more and 50 μm or less, and preferably 1 μm or more and 10 μm or less such as polyethylene terephthalate film, 1,4-polycyclohexylene dimethylene terephthalate film, polyethylene naphthalate film, polyphenylene sulfide film, polystyrene film, polypropylene film, polysulfone film, aramid film, polycarbonate film, polyvinyl alcohol film, cellophane, cellulose derivatives such as cellulose acetate, polyethylene film, polyvinyl chloride film, nylon film, polyimide film, and ionomer film. Moreover, these materials can be used each alone, but may be used as laminates combined with other materials.

In addition, the substrate 1 may be provided with an adhesive on the face on which the respective colorant layers 2Y, 2M, and 2C are formed By applying an adhesion treatment, it is possible to improve the adhesiveness between the substrate 1 and the respective colorant layers 2Y, 2M, and 2C, or the adhesiveness between the substrate 1 and an optional layer provided between the substrate 1 and the respective colorant layers 2Y, 2M, and 2C, such as the primer layer 3.

As the adhesion treatment, it is possible to apply heretofore known resin surface treatment techniques such as corona discharge treatment, flame treatment, ozone treatment, ultraviolet ray treatment, radioactive ray treatment, surface roughening treatment, chemical substance treatment, plasma treatment, low-temperature plasma treatment, and grafting treatment. In addition, two or more of these treatments can also be used in combination. Instead of applying an adhesion treatment to the substrate 1, a primer layer 3 (sometimes, referred to as an under coat layer) may be provided between the substrate 1 and each of the colorant layers 2Y, 2M, and 2C. Alternatively, a primer layer 3 may also be provided between the substrate 1 subjected to adhesive treatment and each of the colorant layers 2Y, 2M, and 2C.

### (Yellow Colorant Layer)

Yellow Colorant

As shown in FIG. 1, the yellow colorant layer 2Y is provided on the substrate 1, at least a colorant represented by the following general formula (Y-I) is contained in the yellow colorant layer 2Y, wherein the content of the colorant represented by the following general formula (Y-I) on the basis of the total mass of the whole of the colorants contained in the yellow colorant layer is 60% by mass or more.

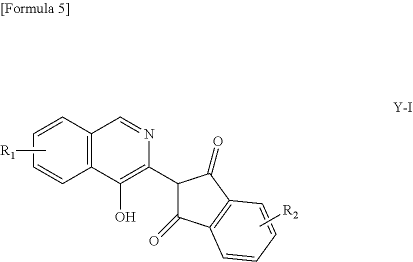

(In the general formula (Y-I), R₁ represents a linear or branched alkyl group having 8 or less carbon atoms, a substituted or unsubstituted aryl group, a hydrogen atom, or a halogen atom; and R₂ represents a substituted or unsubstituted aminocarbonyl group or a substituted or unsubstituted alkoxycarbonyl group.)

The colorant represented by the general formula (Y-I) is a so-called quinophthalone-based colorant, is well balanced with respect to the density, lightfastness, and colorant stability, and is characterized by a low catalytic fading among various yellow colorants. When a colorant other than this colorant is used, an achievement of a density frequently goes with a failure such as an unfavorable lightfastness, a high catalytic fading, or an occurrence of a precipitate. It is to be noted that the catalytic fading means a phenomenon that the lightfastness is degraded by the interaction between the colorants. By containing the colorant represented by the general formula (Y-I) in a content of 60% by mass or more on the basis of the total mass of the whole of the colorants contained in the yellow colorant layer, the above-mentioned operation and effect can be efficiently displayed. The upper limit of the content of the colorant represented by the general formula (Y-I) is not particularly limited, but is preferably 100% by mass.

In the general formula (Y-I), R1 is preferably a linear or branched alkyl group having 8 or less carbon atoms, more preferably a linear or branched alkyl group having 3 to 6 carbon atoms, and particularly preferably a branched butyl group. R₂ is preferably an alkylaminocarbonyl group represented by C(═O)—NR₃R₄. Herein, R₃ and R₄ in the alkylaminocarbonyl group are each preferably a linear or branched alkyl group having 1 to 6 carbon atoms, and more preferably a linear or branched alkyl group having 3 to 6 carbon atoms. Such an R₂ is particularly preferably a N,N-dibutylamino group.

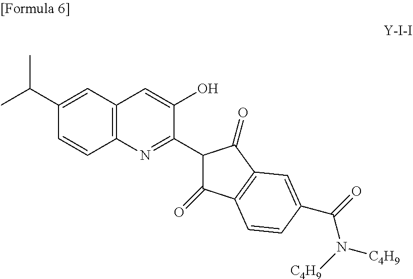

In the yellow colorant layer 2Y in the Sublimation thermal transfer sheet 10 according to the present embodiment, a colorant other than the colorant represented by the general formula (Y-I) may be contained as a colorant. For example, the following heretofore known yellow colorant may be used: a diarylmethane-based colorant; a triarylmethane-based colorant; a thiazole-based colorant; a merocyanine-based colorant; a methine-based colorant such as pyrazolonemethine; an indoaniline-based colorant; an azomethine-based colorant typified by acetophenone azomethine, pyrazolo azomethine, imidazole azomethine, imidazo azomethine, and pyridone azomethine; a xanthene-based colorant; oxazine-based colorant; a cyanostyrene-based colorant typified by dicyanostyrene, and tricyanostyrene; a thiazine-based colorant; an azine-based colorant; an acridine-based colorant; a benzene azo-based colorant; azo-based colorants other than the colorant represented by the general formula (Y-I) such as pyridone azo, thiophene azo, isothiazole azo, pyrrole azo, pyrral azo, imidazole azo, thiadiazole azo, triazole azo, and disazo; a spiropyran-based colorant; an indolinospiropyran-based colorant; a fluoran-based colorant; a rhodamine lactam-based colorant; a naphthoquinone-based colorant; an anthraquinone-based colorant; a quinophthalone-based colorant.

Because of being available as commercial products, Dterse Yellow 201 (Macrolex Yellow 6G, Lanxess GmbH) and Solvent Yellow 93 (for example, Plast Yellow 8000 (trade name)) and the like represented by the following general formula (Y-II) are particularly preferable.

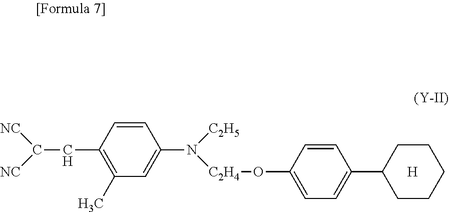

Binder Resin

The yellow colorant layer 2Y in the Sublimation thermal transfer sheet 10 according to the present embodiment contains a binder resin for carrying the various sublimable colorants as described above, including the colorant represented by the general formula (Y-I). This binder resin is not particularly limited, and resins having a certain degree of heat resistance and a moderate affinity with the sublimable colorant can be used. Examples of such a binder resin include cellulose-based resins such as nitrocellulose, ethyl cellulose, hydroxyethyl cellulose, ethyl hydroxy cellulose, hydroxypropyl cellulose, methyl cellulose, cellulose acetate, and cellulose butyrate; vinyl-based resins such as polyvinyl alcohol, polyvinyl acetate, polyvinyl butyral, polyvinyl acetoacetal, and polyvinyl pyrrolidone; acryl resins such as poly(meth)acrylate, and poly(meth)acrylamide; a polyurethane-based resin; a polyamide-based resin; a polyester-based resin; and the like.

Among the above-mentioned other binder resins, polyvinyl butyral resin and polyvinyl acetal resin are preferable because the adhesiveness to the primer layer 3 optionally provided between the substrate 1 and the yellow colorant layer 2Y can be improved.

The content of the binder resin is not particularly limited; however, when the content of the binder resin is less than 20% by mass in relation to the total solid content of the yellow colorant layer 2Y, the colorant cannot be sufficiently held in the yellow colorant layer 2Y, and thus the storage stability tends to be degraded. Accordingly, the binder resin is preferably contained in a content of 20% by mass or more in relation to the total solid content of the yellow colorant layer 2Y. The upper limit of the content of the binder resin is not particularly limited, and can be appropriately set according to the contents of the colorant and the optional additive materials.

In addition, by increasing the mass ratio (colorant/binder resin, hereinafter referred to as the D/B ratio) between the colorant and the binder resin, a further improvement of the density can also be achieved. Specifically, by setting the D/B ratio to be 1.0 or more, it is possible to impart a high density to the print obtained by using the Sublimation thermal transfer sheet 10 according to the present embodiment. It is to be noted that the mass of the sublimable colorant means the total mass of all the sublimable colorants contained in the yellow colorant layer 2Y, and the mass of the binder resin means the total mass of all the binder resins contained in the yellow colorant layer 2Y.

The preferable upper limit of the D/B ratio is not particularly limited; however, when the D/B ratio exceeds 3.5, the colorant amount of the colorant relative to the binder resin is too large, and thus sometimes the binder resin cannot hold the colorant to degrade the storage stability. Accordingly, in consideration of this, the D/B ratio is preferably within a range of 0.7 or more and 3.5 or less, and particularly preferably within a range of 1.0 or more and 2.0 or less.

Other Components

The yellow colorant layer 2Y may also contain additive materials such as inorganic fine particles and organic fine particles. Examples of the inorganic fine particles include fine particles of carbon black, aluminum, and molybdenum disulfide; examples of the organic fine particles include polyethylene wax fine particles and silicone resin fine particles.

The yellow colorant layer 2Y may also contain a release agent. Examples of the release agent include modified or unmodified silicone oil (inclusive of materials referred to as silicone resin), a phosphoric acid ester, a fatty acid ester, and the like.

Method of Forming Yellow Colorant Layer

The method of forming the yellow colorant layer 2Y is not particularly limited; the yellow colorant layer 2Y can be formed as follows: a binder resin, a colorant(s), and additive materials and a release agent added if necessary are dissolved or dispersed in an appropriate solvent to prepare a coating liquid for the yellow colorant layer; the coating liquid for the yellow colorant layer is applied to the substrate 1 or the primer layer 3 described later with a heretofore known coating device such as a gravure coater, a roll coater, and a wire bar; then the applied coating liquid is dried to form the yellow colorant layer. It is to be noted that the coating devices of the various coating liquids to be described later are also the same as described herein. In general, the thickness of the yellow colorant layer 2Y is 0.2 μm or more and 2.0 μm or less.

### (Magenta Colorant Layer)

Magenta Colorant

As shown in FIG. 1, the magenta colorant layer 2M is provided on the substrate 1, and the magenta colorant layer 2M contains at least the colorant represented by the following general formula (M-I), and either one or both of the colorant represented by the following general formula (M-II) and the colorant represented by the general formula (M-III). In other words, the present embodiment includes the following three combinations.

(1) A combination of (M-I) and (M-II)
(2) A combination of (M-I) and (M-III)
(3) A combination of (M-I), (M-II) and (M-III)

In addition, as one of the features, in any one of the above-mentioned combinations, the content of the colorant represented by the following general formula (M-I) on the basis of the total mass of the whole of the colorants contained in the magenta colorant layer is 10% by mass or more and 50% by mass or less.

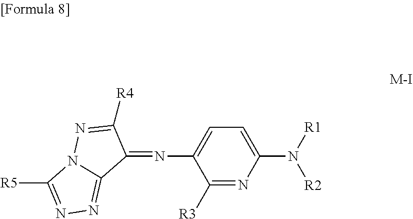

(In the general formula (M-I), R1 and R2 each represent a hydrogen atom, a linear or branched alkyl group, a substituted or unsubstituted cycloalkyl group or a substituted or unsubstituted aralkyl group; R3 represents a linear or branched alkyl group, a substituted or unsubstituted alkoxy group, a substituted or unsubstituted alkylcarbonylamino group, a substituted or unsubstituted alkylsulfonylamino group, a substituted or unsubstituted alkylaminocarbonyl group, a substituted or unsubstituted alkylaminosulfonyl group, a hydrogen atom or a halogen atom; and R4 and R5 each represent a linear or branched alkyl group, a substituted or unsubstituted aryl group, a substituted or unsubstituted amino group, a substituted or unsubstituted cycloalkyl group, a cyano group, a nitro group or a halogen atom.)

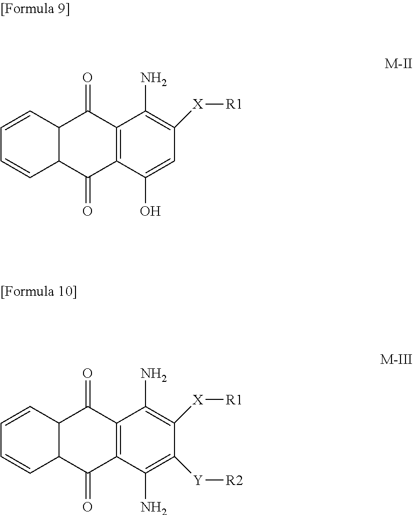

(In the general formulas (M-II) and (M-III), X and Y each represent S, O or SO₂; and R1 and R2 each represent a linear or branched alkyl group, a substituted or unsubstituted cycloalkyl group, a substituted or unsubstituted aryl group or a substituted or unsubstituted allyl group.)

As the magenta colorant, the colorant represented by the general formula (M-I) is an essential colorant. This colorant is characterized by being extremely excellent in density. On the other hand, the colorant represented by the general formula (M-II) and the colorant represented by the general formula (M-III) used in combination with the colorant represented by the general formula (M-I) are so-called anthraquinone-based colorants, are excellent in light fastness, but give density moderately. In the present embodiment, by using in combination colorants different in type from each other, the balance between the density and the lightfastness can be maintained satisfactorily. Accordingly, the colorant represented by the general formula (M-I) is required to be contained in a content of more than 10% by mass; on the other hand, when the aforementioned colorant is contained in a content of more than 50% by mass, the lightfastness of the red color is liable to be degraded, and accordingly the upper limit of the content of the aforementioned colorant is 50% by mass, and preferably 35% by mass.

In the general formula (M-I), R1 and R2 are each preferably a linear or branched alkyl group having 1 to 6 carbon atoms, more preferably a linear alkyl group having 1 to 3 carbon atoms, and particularly preferably an ethyl group. R3 is preferably a linear or branched alkyl group having 1 to 6 carbon atoms, more preferably a linear alkyl group having 1 to 3 carbon atoms, and particularly preferably a methyl group. R4 is preferably a linear or branched alkyl group having 1 to 6 carbon atoms, more preferably a branched alkyl group having 3 to 6 carbon atoms, and particularly preferably a tertiary butyl group. R5 is preferably a substituted or unsubstituted aryl group, more preferably a substituted or unsubstituted phenyl group, and particularly preferably an m-toluic group. In particular, the following general formula (M-I-I) is preferable.

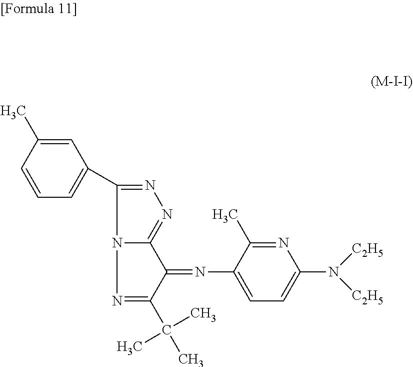

In the general formula (M-II), R1 is preferably a substituted or unsubstituted aryl group, more preferably a substituted or unsubstituted phenyl group, and particularly preferably an unsubstituted phenyl group. In addition, X is preferably 0. In particular, the following general formula (M-II-I) is preferable. In the general formula (M-III), R1 and R2 are each preferably a substituted or unsubstituted aryl group, more preferably a substituted or unsubstituted phenyl group, and particularly preferably an unsubstituted phenyl group. In addition, X and Y are each preferably 0. In particular, the following general formula (M-III-I) is preferable.

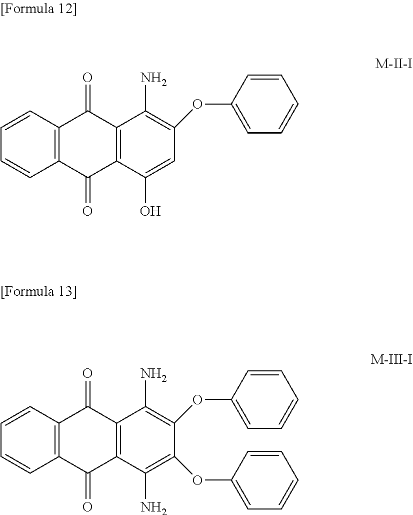

In the magenta colorant layer 2M in the Sublimation thermal transfer sheet 10 according to the present embodiment, colorants other than the colorants represented by the general formula (M-I), and the general formula (M-II) and the general formula (M-III) may be contained as the colorants. For example, a so-called thiazole-based colorant as a colorant represented by the following general formula (M-IV) may also be contained.

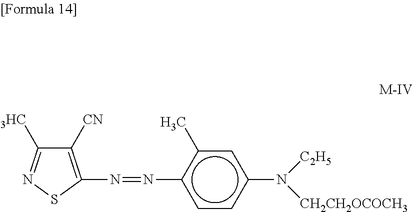

The magenta colorant layer 2M in the Sublimation thermal transfer sheet 10 according to the present embodiment also contains a binder resin in the same manner as in the yellow colorant layer 2Y; however, the description of the binder resin is the same as the description in “⋅ Binder resin” in the yellow colorant layer 2Y, and accordingly the description of the binder resin is omitted herein. In addition, the descriptions of “Other components” and “the method of forming the magenta colorant layer” are the same as the descriptions in the yellow colorant layer 2Y, and accordingly the descriptions are omitted herein.

(Cyan Colorant Layer)

Cyan Colorant

As shown in FIG. 1, the cyan colorant layer 2C is provided on the substrate 1. In the Sublimation thermal transfer sheet 10 in the present embodiment, the colorant contained in the cyan colorant layer 2C is no particularly limited, and heretofore known cyan colorants can be appropriately used.

Specifically, for example, indoaniline-based colorants or anthraquinone-based colorants may be used, and in addition to these, cyanomethylene-based colorants may also be used.

In the cyan colorant layer 2C in the Sublimation thermal transfer sheet 10 according to the present embodiment, a binder resin is contained in the same manner as in the yellow colorant layer 2Y and the magenta colorant layer 2M, the description of the aforementioned binder resin is the same as the description in “⋅ the binder resin” in the yellow colorant layer 2Y, the description of the binder resin is omitted herein. In addition, the descriptions of “⋅ other components” and “the method of forming the cyan colorant layer” are the same as the descriptions in the yellow colorant layer 2Y, and accordingly the descriptions are omitted herein.

### (Black Colorant Layer)

Although not shown in a FIGURE, in the Sublimation thermal transfer sheet in the present embodiment, a black colorant layer may be formed in addition to the above-mentioned three color colorant layers (2Y, 2M, 2C). The black colorant layer is not particularly limited, and may be appropriately selected and adopted from heretofore known black colorant layers.

### (Primer Layer)

As shown in FIG. 1, in the Sublimation thermal transfer sheet 10 according to the present embodiment, the primer layer 3 is provided between the substrate 1 and each of the colorant layers 2Y, 2M, and 2C. The primer layer 3 is an optional layer, but by providing this layer, the adhesiveness between the substrate 1 and each of the colorant layers 2Y, 2M, and 2C can be improved.

Examples of the resin constituting the primer layer 3 include a polyester-based resin, a polyvinylpyrrolidone resin, a polyvinyl alcohol resin, a hydroxyethyl cellulose, a polyacrylic acid ester-based resin, a polyvinyl acetate-based resin, a polyurethane-based resin, a styrene acrylate-based resin, a polyacrylamide-based resin, a polyamide-based resin, a polyether-based resin, a polystyrene-based resin, a polyethylene-based resin, a polypropylene-based resin, a polyvinyl chloride-based resin, and polyvinyl acetal-based resins such as polyvinyl acetoacetal and polyvinyl butyral.

The primer layer 3 may also contain inorganic fine particles. Herewith, the abnormal transfer of each of the colorant layers 2Y, 2M, and 2C to the thermal transfer image-receiving sheet at the time of thermal transfer can be prevented, additionally the transfer of the colorant to the primer layer 3 from each of the colorant layers 2Y, 2M, and 2C at the time of printing is prevented, the colorant diffusion to the receiving layer side of the thermal transfer image-receiving sheet can be effectively performed, and thus the printing density can be enhanced.

The inorganic fine particles contained in the primer layer 3 are not particularly limited; examples of inorganic fine particles include the fine particles of alumina, silica, carbon black, and molybdenum disulfide; these fine particles may be inorganic fine particles derived from colloidal inorganic fine particles. Examples of the colloidal inorganic fine particles include silica sol, colloidal silica, alumina or alumina hydrate (colloidal alumina, cationic aluminum oxide or the hydrate thereof, pseudo boehmite, and the like), aluminum silicate, magnesium silicate, magnesium carbonate, magnesium oxide, and titanium oxide. Such colloidal inorganic fine particles may be a product treated so as to be acidic type, a product charged positively (+), or a surface-treated product, for the purpose of allowing the inorganic fine particles to be easily dispersed in a sol state in a solvent or a dispersion medium.

The shape of the inorganic fine particles contained in the primer layer 3 is not particularly limited, may be any shape such as a spherical shape, an acicular shape, a plate-like shape, a feather-like shape, and an amorphous shape. The particle size of the inorganic fine particles is not particularly limited; however, when the primer layer 3 mainly contains inorganic fined particles having a primary particle size of more than 100 nm, the transparency of the primer layer 3 tends to be degraded. In consideration of this, the primer layer 3 contains mainly inorganic fine particles having a primary particle size of preferably 100 nm or less, more preferably 50 nm or less, and particularly preferably 30 nm or less. It is to be noted that the size of the primary particle may be visually measured with a scanning electron microscope (SEM), a transmission electron microscope (TEM), and the like, or alternatively may be mechanically measured with a particle size distribution meter or the like, using a dynamic light scattering method, a static light scattering method or the like. Herein, the term “mainly” means 50% by mass or more on the basis of the total mass of the inorganic fine particles contained in the primer layer 3. The lower limit of the particle size is not particularly limited, but is usually approximately 0.1 nm in terms of the primary particle size, and preferably 3 nm or more.

The primer layer 3 can be formed as follows: a coating liquid for the primer layer is prepared by dissolving or dispersing the resin and inorganic fine particles shown above as examples in an appropriate solvent, the prepared coating liquid is applied to one surface of the substrate 1 by using a heretofore known coating device, and the applied coating liquid is dried. The coating amount of the coating liquid for the primer layer is not particularly limited, but is preferably an amount to give the thickness of the primer layer after drying of 0.02 μm or more and 1.0 μm or less.

In addition, together with or alternatively in place of the primer layer 3, various functional layers may be provided. Examples of the various functional layers may include an antistatic layer.

### (Back Face Layer)

As shown in FIG. 1, a back face layer 5 is provided on the face of the substrate 1 opposite to the face of the substrate 1 on which the respective colorant layers 2Y, 2M, and 2C are provided. The back face layer 5 is also an optional layer as it is the case for the primer layer 3; however, by providing the back face layer 5, it is possible to improve, for example, the heat resistance and the travelling performance of the thermal head at the time of printing.

The back face layer 5 can be formed by appropriately selecting, for example, a heretofore known thermoplastic resin. Examples of such a thermoplastic resin include thermoplastic resins such as a polyester-based resin, a polyacrylic acid ester-based resin, a polyvinyl acetate-based resin, a styrene-acrylate-based resin, a polyurethane-based resin, polyolefin-based resins such as a polyethylene-based resin and a polypropylene-based resin, polystyrene-based resin, a polyvinyl chloride-based resin, a polyether-based resin, a polyamide-based resin, a polyimide-based resin, a polyamideimide-based resin, a polycarbonate-based resin, a polyacrylamide resin, a polyvinyl chloride resin, a polyvinyl butyral resin, a polyvinyl acetal resin such as a polyvinyl acetoacetal resin; and silicone-modified products of these.

In addition, curing agents may also be added to the above-mentioned resins. As the polyisocyanate resin functioning as a curing agent, heretofore known polyisocyanate resins functioning as a curing agent can be used without being particularly limited; however, among these, adducts of aromatic isocyanates are preferably used. Examples of the aromatic polyisocyanate include 2,4-toluene diisocyanate, 2,6-toluene diisocyanate, or, a mixture of 2,4-toluene diisocyanate and 2,6-toluene diisocyanate, 1,5-naphthalene diisocyanate, tolidine diisocyanate, p-phenylene diisocyanate, trans-cyclohexane-1,4-diisocyanate, xylylene diisocyanate, triphenylmethane triisocyanate, and tris(isocyanatephenyl)thiophosphate; in particular, 2,4-toluene diisocyanate, 2,6-toluene diisocyanate, or, the mixture of 2,4-toluene diisocyanate and 2,6-toluene diisocyanate is preferable. Such polyisocyanate resins as mentioned above allow the above-mentioned hydroxyl group-containing thermoplastic resins to be cross-linked through the use of the hydroxyl groups thereof, and thus allow the coating film strength and the heat resistance of the back face layer to be improved.

In addition, in addition to the above-mentioned thermoplastic resin, for the purpose of improving the slipping property, the back face layer 5 preferably contains various additive materials such as release agents such as wax, a higher fatty acid amide, a phosphoric acid ester compound, a metal soap, a silicone oil, and a surfactant; organic powders such as a fluororesin; inorganic particles such as silica, clay, talc, and calcium carbonate; at least one of a phosphoric acid ester and a metal soap is particularly preferably contained.

The back face layer 5 can be formed for example as follows: a coating liquid for the back face layer is prepared by dispersing or dissolving in an appropriate solvent the above-mentioned thermoplastic resin, and various additive materials added if necessary, the prepared coating liquid is applied to the face of the substrate 1 opposite to the face of the substrate 1 on which the colorant layers are formed by using a heretofore known coating device, and the applied coating liquid is dried. The coating amount of the coating liquid for the back face layer is not particularly limited; however, the coating amount of the aforementioned coating liquid is preferably an amount to give the thickness of the back face layer after drying of preferably 3 μm or less, and more preferably 0.1 μm or more and 2 μm or less.

### (Transfer Receiving Article)

The above-mentioned transfer receiving article to be the counterpart of the Sublimation thermal transfer sheet according to the present embodiment is not particularly limited; examples of the transfer receiving article may include various transfer receiving articles such as a thermal transfer image-receiving sheet provided with a receiving layer, an intermediate transfer medium provided with a receiving layer, and a so-called card material. Among these, the Sublimation thermal transfer sheet according to the present embodiment can be suitably used for a card material wherein the magnitude of deflection in the flexural strength test specified in JIS X 6305-1 is 35 mm or less. Because such a card material is stiff, in general such a card material is incompatible with the thermal transfer, and even when thermal transfer is performed, a desired color cannot be reproduced sometimes; however, the Sublimation thermal transfer sheet according to the present embodiment contains predetermined colorants in predetermined amounts in the yellow colorant layer and the magenta colorant layer, and accordingly allows such a stiff card to form a desired image.

### EXAMPLES

Hereinafter, the present invention will be described with reference to Examples and Comparative Examples. It is to be noted that unless otherwise specified, “parts” in the text are based on mass.

### Example 1

As a substrate, a polyethylene terephthalate film having a thickness of 5 μm was used, a coating liquid for a back face layer having the following composition was applied to the substrate so as for the thickness after drying to be 1.0 μm, and thus the back face layer was formed. Next, a coating liquid for a primer layer having the following composition was applied to the face of the substrate opposite to the face provided with the back face layer, so as for the thickness after drying to be 0.10 μm, and thus the primer layer was formed. Next, on the primer layer, a coating liquid Y1 for a yellow colorant layer having the following composition, a coating liquid M1 for a magenta colorant layer having the following composition, and a coating liquid C1 for a cyan colorant layer having the following composition were applied, in this order as being frame sequentially, in such a way that the thickness after drying of each of these layers was 0.35 μm, and dried (at 80° C., for 2 minutes) to form a yellow colorant layer, a magenta colorant layer, and a cyan colorant layer, and thus the Sublimation thermal transfer sheet of Example 1 was obtained.

### <Coating Liquid for Back Face Layer>

| | | |
|---|---|---|
| polyvinyl acetal resin (hydroxyl value: 12% by mass) | 36 | parts |
| (S-LEC (registered trademark) KS-1, Sekisui Chemical | | |
| Co., Ltd.) | | |
| polyisocyanate (NCO = 17.3% by mass) | 25 | parts |
| (BARNOCK (registered trademark) D750, DIC Corp.) | | |
| silicone resin fine particles (particle size: 4 μm, | 1 | part |
| polygonal shape) | | |
| (TOSPEARL 240 Momentive Performance Materials Japan | | |
| LLC) | | |
| zinc stearyl phosphate | 10 | parts |
| (LBT1830, purified, Sakai Chemical Industry Co., Ltd.) | | |
| zinc stearate | 10 | parts |
| (SZ-PF Sakai Chemical Industry Co., Ltd.) | | |
| polyethylene wax | 3 | parts |
| (Polywax 3000, TOYO ADL Corp.) | | |
| ethoxylated alcohol-modified wax | 7 | parts |
| (Unitox 750, TOYO ADL Corp.) | | |
| methyl ethyl ketone | 200 | parts |
| toluene | 100 | parts |

### <Coating Liquid for Primer Layer>

| | |
|---|---|
| alumina sol | 30 parts |
| (average primary particle size: 10 × 100 nm (solid | |
| content: 10%)) | |
| (Alumina Sol 200, Nissan Chemical Industries, Ltd.) | |
| polyvinylpyrrolidone resin | 3 parts |
| (K-90, ISP (Japan) Ltd.) | |
| water | 50 parts |
| Isopropyl alcohol | 17 parts |

### <Coating Liquid Y1 for Yellow Colorant Layer>

| | | |
|---|---|---|
| compound represented by general formula (Y-I-I) | 5.0 | parts |
| (100% by mass in relation to whole of colorants) | | |
| polyvinyl acetoacetal resin | 3.5 | parts |
| (S-LEC (registered trademark) KS-5, Sekisui Chemical | | |
| Co., Ltd.) | | |
| polyolefin wax | 0.2 | part |
| toluene | 45.75 | parts |
| methyl ethyl ketone | 45.75 | parts |

### <Coating Liquid M1 for Magenta Colorant Layer>

| | | |
|---|---|---|
| compound represented by general formula (M-I-I) | 0.5 | part |
| (10% by mass in relation to whole of colorants) | | |
| compound represented by general formula (M-II-I) | 4.5 | parts |
| (90% by mass in relation to whole of colorants) | | |
| polyvinyl acetoacetal resin | 3.5 | parts |
| (S-LEC (registered trademark) KS-5, Sekisui Chemical | | |
| Co., Ltd.) | | |
| polyolefin wax | 0.2 | part |
| toluene | 45.75 | parts |
| methyl ethyl ketone | 45.75 | parts |

### <Coating Liquid C1 for Cyan Colorant Layer>

| | | |
|---|---|---|
| Solvent Blue 63 | 3.0 | parts |
| compound represented by the following general formula | 2.0 | parts |
| (C-I) | | |
| polyvinyl acetoacetal resin | 3.5 | parts |
| (S-LEC (registered trademark)KS-5, Sekisui Chemical Co., | | |
| Ltd.) | | |
| polyolefin wax | 0.2 | part |
| toluene | 45.75 | parts |
| methyl ethyl ketone | 45.75 | parts |

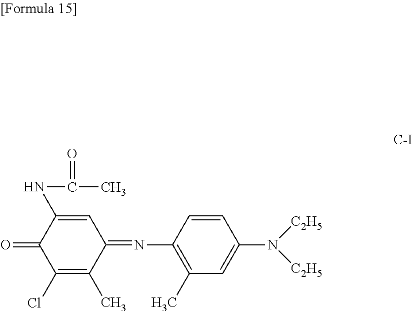 [SMILES: CCN(CC)c1ccc(N=C2C=C(NC(C)=O)C(=O)C(Cl)=C2C)c(C)c1]

### Example 2

The Sublimation thermal transfer sheet of Example 2 was obtained under the same conditions as in Example 1 except that the coating liquid M2 for the magenta colorant layer having the following composition was used in place of the coating liquid M1 for the magenta colorant layer in Example 1.

### <Coating Liquid M2 for Magenta Colorant Layer>

| | | |
|---|---|---|
| Compound represented by general formula (M-I-I) | 1.25 | parts |
| (25% by mass in relation to whole of colorants) | | |
| compound represented by general formula (M-II-I) | 2.0 | parts |
| (40% by mass in relation to whole of colorants) | | |
| compound represented by general formula (M-III-I) | 1.75 | parts |
| (35% by mass in relation to whole of colorants) | | |
| polyvinyl acetoacetal resin | 3.5 | parts |
| (S-LEC (registered trademark)KS-5, Sekisui Chemical Co., | | |
| Ltd.) | | |
| Polyolefin wax | 0.2 | part |
| toluene | 45.75 | parts |
| methyl ethyl ketone | 45.75 | parts |

### Example 3

The Sublimation thermal transfer sheet of Example 3 was obtained under the same conditions as in Example 1 except that the coating liquid M3 for the magenta colorant layer having the following composition was used in place of the coating liquid M1 for the magenta colorant layer in Example 1.

### <Coating Liquid M3 for Magenta Colorant Layer>

| | | |
|---|---|---|
| compound represented by general formula (M-I-I) | 2.5 | parts |
| (50% by mass in relation to whole of colorants) | | |
| compound represented by general formula (M-II-I) | 2.5 | parts |
| (50% by mass in relation to whole of colorants) | | |
| polyvinyl acetoacetal resin | 3.5 | parts |
| (S-LEC KS-5(registered trademark), Sekisui Chemical Co., | | |
| Ltd.) | | |
| polyolefin wax | 0.2 | part |
| toluene | 45.75 | parts |
| methyl ethyl ketone | 45.75 | parts |

### Example 4

The Sublimation thermal transfer sheet of Example 4 was obtained under the same conditions as in Example 1 except that the coating liquid Y2 for the yellow colorant layer having the following composition was used in place of the coating liquid Y1 for the yellow colorant layer in Example 1, and the coating liquid M2 for the magenta colorant layer having the above-mentioned composition was used in place of the coating liquid M1 for the magenta colorant layer in Example 1.

### <Coating Liquid Y2 for Yellow Colorant Layer>

| | | |
|---|---|---|
| compound represented by general formula (Y-I-I) | 3.0 | parts |
| (60% by mass in relation to whole of colorants) | | |
| Disperse Yellow 201 | 2.0 | parts |
| (40% by mass in relation to whole of colorants) | | |
| polyvinyl acetoacetal resin | 3.5 | parts |
| (S-LEC (registered trademark) KS-5, Sekisui Chemical | | |
| Co., Ltd.) | | |
| polyolefin wax | 0.2 | part |
| toluene | 45.75 | parts |
| methyl ethyl ketone | 45.75 | parts |

### Example 5

The Sublimation thermal transfer sheet of Example 5 was obtained under the same conditions as in Example 1 except that the coating liquid Y3 for yellow colorant layer having the following composition was used in place of the coating liquid Y1 for the yellow colorant layer in Example 1, and the coating liquid M4 for the magenta colorant layer having the following composition was used in place of the coating liquid M1 for the magenta colorant layer in Example 1.

### <Coating Liquid Y3 for Yellow Colorant Layer>

| | | |
|---|---|---|
| compound represented by general formula (Y-I-I) | 3.5 | parts |
| (70% by mass in relation to whole of colorants) | | |
| Disperse Yellow 231 | 1.5 | parts |
| (30% by mass in relation to whole of colorants) | | |
| polyvinyl acetoacetal resin | 3.5 | parts |
| (S-LEC (registered trademark) KS-5, Sekisui Chemical | | |
| Co., Ltd.) | | |
| polyolefin wax | 0.2 | part |
| toluene | 45.75 | parts |
| methyl ethyl ketone | 45.75 | parts |

### <Coating Liquid M4 for Magenta Colorant Layer>

| | | |
|---|---|---|
| compound represented by general formula (M-I-I) | 1.25 | parts |
| (25% by mass in relation to whole of colorants) | | |
| compound represented by general formula (M-II-I) | 3.75 | parts |
| (75% by mass in relation to whole of colorants) | | |
| polyvinyl acetoacetal resin | 3.5 | parts |
| (S-LEC (registered trademark) KS-5, Sekisui Chemical | | |
| Co., Ltd.) | | |
| polyolefin wax | 0.2 | part |
| toluene | 45.75 | parts |
| methyl ethyl ketone | 45.75 | parts |

### Example 6

The Sublimation thermal transfer sheet of Example 6 was obtained under the same conditions as in Example 1 except that the coating liquid Y4 for the yellow colorant layer having the following composition was used in place of the coating liquid Y1 for the yellow colorant layer in Example 1, and the coating liquid M2 for the magenta colorant layer having the above-mentioned composition was used in place of the coating liquid M1 for the magenta colorant layer Example 1.

### <Coating Liquid Y4 for Yellow Colorant Layer>

| | | |
|---|---|---|
| compound represented by general formula (Y-I-I) | 4.0 | parts |
| (80% by mass in relation to whole of colorants) | | |
| Solvent Yellow 93 | 1.0 | part |
| (20% by mass in relation to whole of colorants) | | |
| polyvinyl acetoacetal resin | 3.5 | parts |
| (S-LEC (registered trademark) KS-5, Sekisui Chemical | | |
| Co., Ltd.) | | |
| polyolefin wax | 0.2 | part |
| toluene | 45.75 | parts |
| methyl ethyl ketone | 45.75 | parts |

### Comparative Example 1

The Sublimation thermal transfer sheet of Comparative Example 1 was obtained under the same conditions as in Example 1 except that the coating liquid M5 for the magenta colorant layer having the following composition was used in place of the coating liquid M1 for the magenta colorant layer in Example 1.

### <Coating Liquid M5 for Magenta Colorant Layer>

| | | |
|---|---|---|
| compound represented by general formula (M-II-I) | 5.0 | parts |
| (100% by mass in relation to whole of colorants) | | |
| polyvinyl acetoacetal resin | 3.5 | parts |
| (S-LEC (registered trademark) KS-5, Sekisui Chemical | | |
| Co., Ltd.) | | |
| polyolefin wax | 0.2 | part |
| toluene | 45.75 | parts |
| methyl ethyl ketone | 45.75 | parts |

### Comparative Example 2

The Sublimation thermal transfer sheet of Comparative Example 2 was obtained under the same conditions as in Example 1 except that the coating liquid M6 for the magenta colorant layer having the following composition was used in place of the coating liquid M1 for the magenta colorant layer in Example 1.

### <Coating Liquid M6 for Magenta Colorant Layer>

| | | |
|---|---|---|
| compound represented by general formula (M-I-I) | 0.25 | part |
| (5% by mass in relation to whole of colorants) | | |
| compound represented by general formula (M-II-I) | 4.75 | parts |
| (95% by mass in relation to whole of colorants) | | |
| polyvinyl acetoacetal resin | 3.5 | parts |
| (S-LEC (registered trademark) KS-5, Sekisui Chemical | | |
| Co., Ltd.) | | |
| polyolefin wax | 0.2 | part |
| toluene | 45.75 | parts |
| methyl ethyl ketone | 45.75 | parts |

### Comparative Example 3

The Sublimation thermal transfer sheet of Comparative Example 3 was obtained under the same conditions as in Example 1 except that the coating liquid M7 for the magenta colorant layer having the following composition was used in place of the coating liquid M1 for the magenta colorant layer in Example 1.

### <Coating Liquid M7 for Magenta Colorant Layer>

| | | |
|---|---|---|
| compound represented by general formula (M-I-I) | 3.5 | parts |
| (70% by mass in relation to whole of colorants) | | |
| compound represented by general formula (M-II-I) | 1.5 | parts |
| (30% by mass in relation to whole of colorants) | | |
| polyvinyl acetoacetal resin | 3.5 | parts |
| (S-LEC (registered trademark) KS-5, Sekisui Chemical | | |
| Co., Ltd.) | | |
| Polyolefin wax | 0.2 | part |
| toluene | 45.75 | parts |
| methyl ethyl ketone | 45.75 | parts |

### Comparative Example 4

The Sublimation thermal transfer sheet of Comparative Example 4 was obtained under the same conditions as in Example 1 except that the coating liquid Y5 for the yellow colorant layer having the following composition was used in place of the coating liquid Y1 for the yellow colorant layer in Example 1, and the coating liquid M4 for the magenta colorant layer having the above-mentioned composition was used in place of the coating liquid M1 for the magenta colorant layer in Example 1.

### <Coating Liquid Y5 for Yellow Colorant Layer>

| | | |
|---|---|---|
| compound represented by general formula (Y-I-I) | 2.0 | parts |
| (40% by mass in relation to whole of colorants) | | |
| Disperse Yellow 201 | 3.0 | parts |
| (60% by mass in relation to whole of colorants) | | |
| polyvinyl acetoacetal resin | 3.5 | parts |
| (S-LEC (registered trademark) KS-5, Sekisui Chemical | | |
| Co., Ltd.) | | |
| polyolefin wax | 0.2 | part |
| toluene | 45.75 | parts |
| methyl ethyl ketone | 45.75 | parts |

### Comparative Example 5

The Sublimation thermal transfer sheet of Comparative Example 5 was obtained under the same conditions as in Example 1 except that the coating liquid M8 for the magenta colorant layer having the following composition was used in place of the coating liquid M1 for the magenta colorant layer in Example 1.

### <Coating Liquid M8 for Magenta Colorant Layer>

| | | |
|---|---|---|
| compound represented by general formula (M-I-I) | 1.25 | parts |
| (25% by mass in relation to whole of colorants) | | |
| compound represented by following general formula (M-V) | 3.75 | parts |
| (75% by mass in relation to whole of colorants) | | |
| polyvinyl acetoacetal resin | 3.5 | parts |
| (S-LEC (registered trademark) KS-5, Sekisui Chemical | | |
| Co., Ltd.) | | |
| polyolefin wax | 0.2 | part |
| toluene | 45.75 | parts |
| methyl ethyl ketone | 45.75 | parts |

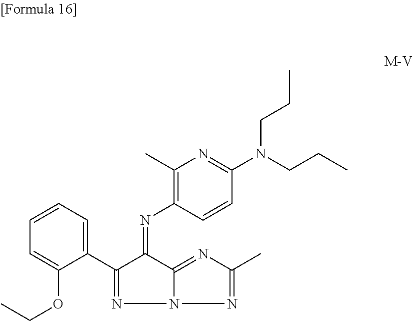 [SMILES: CCCN(CCC)c1ccc(/N=C2/C(c3ccccc3OCC)=Nn3nc(C)nc32)c(C)n1]

### Comparative Example 6

The Sublimation thermal transfer sheet of Comparative Example 6 was obtained under the same conditions as in Example 1 except that the coating liquid M9 for the magenta colorant layer having the following composition was used in place of the coating liquid M1 for the magenta colorant layer in Example 1.

### <Coating Liquid M9 for Magenta Colorant Layer>

| | | |
|---|---|---|
| compound represented by general formula (M-II-I) | 2.0 | parts |
| (40% by mass in relation to whole of colorants) | | |
| compound represented by general formula (M-III-I) | 1.75 | parts |
| (35% by mass in relation to whole of colorants) | | |
| compound represented by following general formula (M- | 1.25 | parts |
| VI) (25% by mass in relation to whole of colorants) | | |
| polyvinyl acetoacetal resin | 3.5 | parts |
| (S-LEC (registered trademark) KS-5, Sekisui Chemical | | |
| Co., Ltd.) | | |
| polyolefin wax | 0.2 | part |
| toluene | 45.75 | parts |
| methyl ethyl ketone | 45.75 | parts |

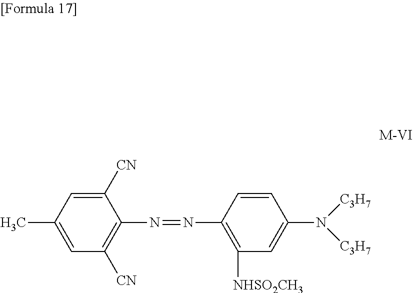

### Comparative Example 7

The Sublimation thermal transfer sheet of Comparative Example 7 was obtained under the same conditions as in Example 1 except that the coating liquid M10 for the magenta colorant layer having the following composition was used in place of the coating liquid M1 for the magenta colorant layer in Example 1.

### <Coating Liquid M10 for Magenta Colorant Layer>

| | | |
|---|---|---|
| compound represented by general formula (M-II-I) | 2.0 | parts |
| (40% by mass in relation to whole of colorants) | | |
| compound represented by general formula (M-III-I) | 1.75 | parts |
| (35% by mass in relation to whole of colorants) | | |
| compound represented by following general formula (M- | 1.25 | parts |
| VII) (25% by mass in relation to whole of colorants) | | |
| polyvinyl acetoacetal resin | 3.5 | parts |
| (S-LEC (registered trademark) KS-5, Sekisui Chemical | | |
| Co., Ltd.) | | |
| polyolefin wax | 0.2 | part |
| toluene | 45.75 | parts |
| methyl ethyl ketone | 45.75 | parts |

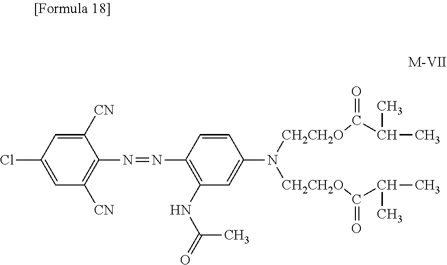

### (Preparation of Intermediate Transfer Medium)

A release layer was formed as follows: a PET film having a thickness of 12 μm was used as a substrate, a coating liquid for forming the release layer having the following composition was applied to one face of the substrate by a gravure coating method in such a way that a layer of 1.0 μm in thickness was obtained after drying, and the applied coating liquid was dried to form the release layer. Next, a protective layer was formed on the release layer as follows: the following coating liquid for forming a protective layer was applied to the release layer by a gravure coating method in such a way that a layer of 2.0 μm in thickness was obtained after drying, and the applied coating liquid was dried to form the protective layer. Next, a primer layer was formed on the protective layer as follows: the following coating liquid for forming a primer was applied to the protective layer by a gravure coating method in such a way that a layer of 1.0 μm in thickness was obtained after drying, and the applied coating liquid was dried to form the primer layer. Next, a receiving layer was formed on the primer layer as follows: the following coating liquid for forming a receiving layer was applied to the primer layer by a gravure coating method in such a way that a layer of 2.5 μm in thickness was obtained after drying, and the applied coating liquid was dried to form the receiving layer; thus, an intermediate transfer medium was prepared.

### <Coating Liquid for Forming Release Layer>

| | | |
|---|---|---|
| acrylic resin | 95 | parts |
| (Dianal (registered trademark) BR-87, Mitsubishi Rayon | | |
| Co., Ltd.) | | |
| polyester resin | 5 | parts |
| (Vylon (registered trademark) 200, Toyobo Co., Ltd.) | | |
| toluene | 200 | parts |
| methyl ethyl ketone | 200 | parts |

### <Coating Liquid for Forming Protective Layer>

| | | |
|---|---|---|
| styrene-acryl-based resin | 150 | parts |
| (MUTICLE (registered trademark) PP320P, Mitsui | | |
| Chemicals, Inc.) | | |
| polyvinyl alcohol | 100 | parts |
| (C-318, DNP Fine Chemicals Co., Ltd.) | | |
| water | 23.3 | parts |
| ethanol | 46.7 | parts |

### <Coating Liquid for Forming Primer Layer>

| | |
|---|---|
| polyester resin | 33 parts |
| (Vylon (registered trademark) 200, Toyobo Co., Ltd.) | |
| vinyl chloride-vinyl acetate copolymer | 27 parts |
| (Solbin (registered trademark) CNL, Nissin Chemical | |
| Industry Co., Ltd.) | |
| isocyanate curing agent | 15 parts |
| (XEL curing agent, DIC Graphics Corp.) | |
| toluene | 50 parts |
| methyl ethyl ketone | 50 parts |

### <Coating Liquid for Forming Receiving Layer>

| | | |
|---|---|---|
| vinyl chloride-vinyl acetate copolymer | 95 | parts |
| (number average molecular weight (Mn): 12000) | | |
| (Solbin (registered trademark) CNL, Nissin Chemical | | |
| Industry Co., Ltd.) | | |
| epoxy-modified silicone | 5 | parts |
| (KP-1800U, Shin-Etsu Chemical Co., Ltd.) | | |
| toluene | 200 | parts |
| methyl ethyl ketone | 200 | parts |

### (Preparation of Protective Layer Transfer Sheet)

A polyethylene terephthalate (PET) film having a thickness of 4.5 μm was used as a substrate, a coating liquid for a release layer having the following composition was applied to one face of the substrate with a wire coater bar in such a way that the thickness after drying was 1.0 μm, the applied coating liquid was dried in an oven at 110° C. for 1 minute, and thus a release layer was formed. Next, to the release layer, a coating liquid for the primer layer having the following composition was applied with a wire coater bar in such a way that the thickness after drying was 0.2 μm, the applied coating liquid was dried in an oven at 110° C. for 1 minute, and thus a primer layer was formed. Next, to the primer layer, coating liquid for an adhesive layer having the following composition was applied with a wire coater bar in such a way that the thickness after drying was 1.0 μm, the applied coating liquid was dried in an oven at 110° C. for 1 minute, and thus an adhesive layer was formed. In addition, to the other face of the substrate, a coating liquid for the back face layer having the following composition was applied with a wire coater bar in such a way that the thickness after drying was 1.0 μm, and the applied coating liquid was dried to preliminarily form a back face layer. Herewith, there was obtained a protective layer transfer sheet in which on one face of the substrate, the release layer, the primer layer, and the adhesive layer constituting a transferable protective layer were provided in this order, and on the other face of the substrate the back face layer was provided.

### <Coating Liquid for Release Layer>

| | |
|---|---|
| polymethyl methacrylate (PMMA) | 20 parts |
| (Dianal (registered trademark) BR-87, Mitsubishi Rayon | |
| Co., Ltd.) | |
| toluene | 40 parts |
| methyl ethyl ketone | 40 parts |

### <Coating Liquid for Adhesive Layer>

| | | |
|---|---|---|
| polyester resin | 23.5 | parts |
| (Vylon (registered trademark) 700, Toyobo Co., Ltd.) | | |
| UVA compound | 6 | parts |
| (Tinuvin 900, BASF Japan Ltd.) | | |
| silica filler | 0.5 | part |
| (Sylysia 310P, Fuji Silysia Chemical Ltd.) | | |
| toluene | 35 | parts |
| methyl ethyl ketone | 35 | parts |

### <Coating Liquid for Primer Layer>

| | | |
|---|---|---|
| alumina sol | 30 | parts |
| (average primary particle size: 10 × 100 nm (solid | | |
| content: 10%)) | | |
| (Alumina Sol 200, Nissan Chemical Industries, Ltd.) | | |
| polyvinylpyrrolidone resin | 3 | parts |
| (K-90, ISP (Japan) Ltd.) | | |
| water | 50 | parts |
| isopropyl alcohol | 17 | parts |

### <Coating Liquid for Back Face Layer>

| | | |
|---|---|---|
| polyvinyl butyral resin | 4.55 | parts |
| (S-LEC (registered trademark)BX-1, Sekisui | | |
| Chemical Co., Ltd. ) | | |
| polyisocyanate (solid content: 45% by mass) | 21.0 | parts |
| (BARNOCK (registered trademark) D750-45, | | |
| DIC Corp.) | | |
| phosphoric acid ester-based surfactant | 3.0 | parts |
| (Plysurf (registered trademark) A208N, Dai-ichi | | |
| Kogyo Seiyaku Co., Ltd.) | | |
| talc | 0.7 | part |
| (MICRO ACE (registered trademark) P-3), Nippon | | |
| Talc Co., Ltd. | | |
| methyl ethyl ketone | 35.375 | parts |
| toluene | 35.375 | parts |

### (Preparation of Card)

A card having the following composition was prepared.

| | | |
|---|---|---|
| polyvinyl chloride compound (Degree of polymerization: | 100 | parts |
| 800) (containing additive materials | | |
| such as stabilizer in a content of approximately 10%) | | |
| white pigment (titanium oxide) | 10 | parts |
| plasticizer (dioctyl phthalate) | 0.5 | part |

### (Preparation of First Prints)

By using the Sublimation thermal transfer sheets of Examples 1 to 6 and Comparative Examples 1 to 7, thermal transfer images were formed on the receiving layers of the intermediate transfer media prepared as described above, then to the cards prepared as described above, the transfer layers each composed of the release layer, the protective layer and the receiving layer were retransferred and thus first prints were obtained. The transfer conditions and the retransfer conditions, used in this case, are as follows.

### (Transfer Conditions)

thermal head: KEE-57-12GAN-STA (KYOCERA Corp.)
heat generator average resistance: 3303 (Ω)
main scanning direction printing density: 300 (dpi)
sub-scanning direction printing density: 300 (dpi)
printing voltage: 18 (V)
line period: 1.5 (msec./line)
printing start temperature: 35(° C.)
pulse duty ratio: 85(%)

### (Retransfer Conditions)

laminator: Lamipacker LPD3212 (FUJIPLA Inc.)
temperature: 145° C.
speed: 0.8 (set value)

### (Preparation of Second Prints)

By using the Sublimation thermal transfer sheets of Examples 1 to 6 and Comparative Examples 1 to 7, thermal transfer images were directly formed on the cards prepared as described above. The transfer conditions used in this case are as follows.

### (Transfer Conditions)

printer: card printer
printing pressure: 2.2 (kg/inch)
line period: 3 (msec./line)
thermal head resolution: 300 (dpi)
printing energy: 0.26 (mJ/dot)

Next, on each of the formed thermal transfer images, the transferable protective layer was formed by using the protective layer transfer sheet prepared as described above, and thus a second print was obtained. The transfer conditions used in this case are as follows.

### (Transfer Conditions of Protective Layer)

thermal head: F3598 (Toshiba Hokuto Electronics Corp.)
heat generator average resistance: 5176 (Ω)
main scanning direction printing density: 300 (dpi)
sub-scanning direction printing density: 300 (dpi)
line period: 2 (msec/line)
pulse duty: 85(%)
printing start temperature: 35.5 (° C.)
gradation value: 180/255 gradation

### (Evaluation of Red Lightfastness)

Under the above-mentioned conditions, by using the yellow colorant layer and the magenta colorant layer of each of the Sublimation thermal transfer sheets of Examples 1 to 6 and Comparative Examples 1 to 7, a first print and a second print each having a red image pattern (RGB(255,0,0)) were prepared, and were irradiated with light under the following conditions.
irradiation tester: Ci4000 manufactured by Atlas Corp.
light source: Xenon lamp
filter: inside=CIRA, outside=soda-lime
black panel temperature: 45 (° C.)
irradiation intensity: 1.2 (W/m²), a value measured at 420 (nm)
irradiation energy: 400 (kJ/m²), a value integrated at 420 (nm)

Next, the color difference ΔE*ab of an image before and after the irradiation under the above-mentioned irradiation conditions was measured with a spectrometer (i1, X-Rite, Inc.). In the measurement, measurement was performed in the vicinity of 1.0 of the OD value (optical density) of the red image pattern before irradiation.

ΔE*ab=((Δa*)²+(Δb*)²)^{1/2}

Refer to CIE1976 La*b* color coordinate system (JIS Z8729(1980))

Δa*=a*(after irradiation)−a*(before irradiation)

Δb*=b*(after irradiation)−b*(before irradiation)

It is to be noted that a* and b* are based on the color coordinate system CIE1976 L*a*b*, and each represent a perceived lightness index.

The evaluation criteria of the red lightfastness (ΔE*ab) are as follows.

A: ΔE*ab is less than 5.
B: ΔE*ab is 5 or more and less than 10.
C: ΔE*ab is 10 or more and less than 20.
NG: ΔE*ab is 20 or more.

### (Evaluation of Black Density)

Under the above-mentioned conditions, by using the Sublimation thermal transfer sheet of each of Examples 1 to 6 and Comparative Examples 1 to 7, a first print and a second print each having a black image pattern (RGB(0,0,0)) were prepared. By using a spectrometer (i1, X-Rite, Inc.), the OD value (optical density) of each of the formed black images was measured and evaluated on the basis of the following evaluation criteria.

The evaluation criteria of the black density are as follows.

A: The OD value is 2.0 or more
B: The OD value is 1.8 or more and less than 2.0.
C: The OD value is 1.5 or more and less than 1.8.
NG: The OD value is less than 1.5.

### (Evaluation of Durability)

By using the first print and the second print used in the above-mentioned (evaluation of black density), the abrasion resistance test (Taber test) of the transfer layer on the card surface was performed according to ANSI-INCITS322-2002, 5.9 Surface Abrasion. After 300 cycles, the card surface was visually observed, and evaluated on the basis of the following evaluation criteria.

The evaluation criteria of the durability are as follows.

A: No scratches are caused on the print at all.
B: Scratches are caused slightly on the print, but are of an acceptable level in use.
NG-1: Scratches are caused on the print, and are of a problematic level in use.
NG-2: Large scratches are caused on the print.

### (Evaluation of Blurring)

A first print and a second print were prepared by printing an 18-step image by using each of the Sublimation thermal transfer sheets of Examples 1 to 6 and Comparative Examples 1 to 7, under the above-mentioned conditions. Next, these prints were stored in an environment (dark place) of a temperature of 70° C. and a humidity of 80% RH for 168 hours, and the occurrence or nonoccurrence of blurring in each of the images was visually observed when the images were compared with the images before storage. It is to be noted that the 18 step image is an image in which the density is increased gradually from white and the color becomes black at the 18th stage.

The evaluation criteria of the blurring are as follows.

A: No blurring is found.
B: Slight blurring is found.
C: Blurring is found.

### (Evaluation Results)

The results obtained by performing the above-mentioned respective evaluations are collected in Table 1.

TABLE 1

| | First print (intermediate transfer medium) | | | | Second print (direct print) | | | |
|---|---|---|---|---|---|---|---|---|
| | Lightfastness | Density | | | Lightfastness | Density | | |
| | RED | Bk | Durability | Blurring | RED | Bk | Durability | Blurring |
| Example 1 | A | B | B | A | A | B | B | A |
| Example 2 | B | B | B | A | B | B | B | A |
| Example 3 | B | A | A | A | B | A | B | A |
| Example 4 | B | B | B | A | B | B | B | A |
| Example 5 | B | B | B | A | B | B | B | A |
| Example 6 | B | B | B | A | B | B | B | A |
| Comparative Example 1 | B | NG | NG-2 | A | B | NG | NG-2 | A |
| Comparative Example 2 | B | C | NG-2 | A | B | C | NG-2 | A |
| Comparative Example 3 | NG | A | B | A | NG | A | B | A |
| Comparative Example 4 | NG | B | B | A | NG | B | B | A |
| Comparative Example 5 | NG | A | B | A | NG | A | B | A |
| Comparative Example 6 | NG | C | NG-1 | A | NG | C | NG-1 | A |
| Comparative Example 7 | NG | NG | NG-2 | A | NG | NG | NG-2 | A |

Also from the above-presented results, it has been found that the Sublimation thermal transfer sheets according to Examples of the present invention are excellent in the red lightfastness, also in the black density, and in the durability of the card print, and are free from the occurrence of blurring, even when the prints were prepared by using the intermediate transfer media, and even when the prints were prepared by forming thermal transfer images directly on the cards without using the intermediate transfer media.

### EXPLANATION OF THE NUMERALS

10 Sublimation thermal transfer sheet
1 substrate
2Y yellow colorant layer
2M magenta colorant layer
2Y cyan colorant layer
3 primer layer
5 back face layer

1. A sublimation thermal transfer sheet comprising:
a substrate, and
at least yellow, magenta, and cyan colorant layers provided on the substrate, as being frame sequentially,
wherein the yellow colorant layer contains at least the colorant represented by the following general formula (Y-I), and the content of the colorant represented by the following general formula (Y-I) on the basis of the total mass of the whole of the colorants contained in the yellow colorant layer is 60% by mass or more;
the magenta colorant layer contains at least the colorant represented by the following general formula (M-I), and either one or both of the colorant represented by the following general formula (M-II) and the colorant represented by the general formula (M-III); and
the content of the colorant represented by the following general formula (M-I) on the basis of the total mass of the whole of the colorants contained in the magenta colorant layer is 10% by mass or more and 50% by mass or less, 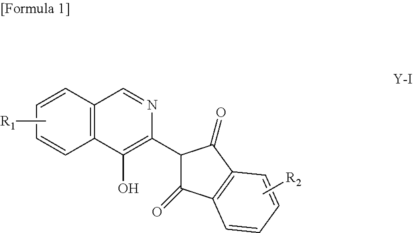
wherein, in the general formula (Y-I), R₁ represents a linear or branched alkyl group having 8 or less carbon atoms, a substituted or unsubstituted aryl group, a hydrogen atom, or a halogen atom; and R₂ represents a substituted or unsubstituted aminocarbonyl group or a substituted or unsubstituted alkoxycarbonyl group, 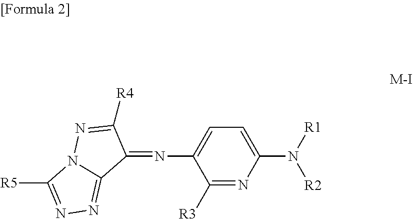
wherein, in the general formula (M-I), R1 and R2 each represent a hydrogen atom, a linear or branched alkyl group, a substituted or unsubstituted cycloalkyl group or a substituted or unsubstituted aralkyl group; R3 represents a linear or branched alkyl group, a substituted or unsubstituted alkoxy group, a substituted or unsubstituted alkylcarbonylamino group, a substituted or unsubstituted alkylsulfonylamino group, a substituted or unsubstituted alkylaminocarbonyl group, a substituted or unsubstituted alkylaminosulfonyl group, a hydrogen atom, or a halogen atom; and R4 and R5 each represent a linear or branched alkyl group, a substituted or unsubstituted aryl group, a substituted or unsubstituted amino group, a substituted or unsubstituted cycloalkyl group, a cyano group, a nitro group, or a halogen atom, 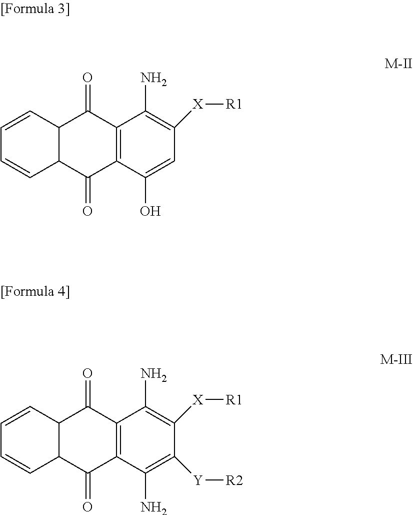
wherein, in the general formulas (M-II) and (M-III), X and Y each represent S, O or SO₂; and R1 and R2 each represent a linear or branched alkyl group, a substituted or unsubstituted cycloalkyl group, a substituted or unsubstituted aryl group, or a substituted or unsubstituted allyl group.

2. A combination of a Sublimation thermal transfer sheet and a transfer receiving article,
wherein the Sublimation thermal transfer sheet is a Sublimation thermal transfer sheet according to claim 1; and
the transfer receiving article is a card material wherein the magnitude of deflection in the flexural strength test specified in JIS X 6305-1 is 35 mm or less.
